(19) United States
(12) Patent Application Publication
(10) Pub. No.: US 2020/0317934 A1
(43) Pub. Date: Oct. 8, 2020

(54) ANTIBACTERIAL COATING LAYER AND COATING METHOD

(71) Applicant: Hsin Fukuang PAINTING CO., LTD., Kaohsiung City (TW)

(72) Inventor: Chien-Cheng LIN, Kaohsiung City (TW)

(21) Appl. No.: 16/837,931

(22) Filed: Apr. 1, 2020

(30) Foreign Application Priority Data
Apr. 2, 2019 (TW) 108111437

(51) Int. Cl. C09D 5/14; C09D 7/61; C09D 7/40; C08K 3/08; C08K 3/22; C09D 133/08; C09D 175/04; B05D 5/00; B05D 1/02

(52) U.S. Cl. CPC C09D 5/14; C09D 7/61; C09D 7/67; C08K 3/08; C08K 3/22; C09D 133/08; B82Y 30/00; B05D 5/00; B05D 1/02; C08K 2003/0806; C08K 2003/2237; C08K 2003/2296; C08K 2201/005; C09D 175/04

(57) ABSTRACT

An antibacterial coating layer comprises a coating material; and a plurality of antibacterial nano-particles, all located near a surface of the coating material. For example, the antibacterial nano-particles are exposed from the surface of the coating material, so that the antibacterial effect of the antibacterial coating layer is not limited, and the best antibacterial effect is achieved.

### CROSS-REFERENCE TO RELATED APPLICATION

This application claims the benefit of Taiwan Patent Application No. 108111437, filed on Apr. 2, 2019, which is hereby incorporated by reference for all purposes as if fully set forth herein.

### BACKGROUND

### Technical Field

The present disclosure relates to an antibacterial coating layer and a coating method therefor, and particularly to an antibacterial coating layer and a coating method therefor in which all of the antibacterial nano-particles are located near a surface of a coating material.

### Related Art

Generally, with the development of society, people's awareness of health and environmental protection is constantly increasing. For example, in the field of surface coating, a coating layer that is merely aesthetic and protective for products has become increasingly unsatisfactory. It is also expected to have a healthy effect.

An example is antibacterial coating layers. Antibacterial nano-particles have unique physical and chemical properties due to their small size effect and surface effect. If antibacterial nano-particles are added to a coating layer, the obtained coating layer has an antibacterial effect. Conventional antibacterial coating layers include two types. One is photocatalytic antibacterial coating layers with nano-titanium dioxide or nano-zinc oxide as antibacterial nano-particles. The photocatalytic nano-antibacterial coating layer has good antibacterial performance in the presence of ultraviolet light, oxygen, and water. The other is antibacterial coating layers with nano-silver as antibacterial nano-particles. The anti-bacterial effect of nano-silver is less affected by the external factors, so it has a wide range of application.

Referring to FIG. 1, the sterilization principle of nano-antibacterial particles 21 in the antibacterial coating layer 20 after the coating step is mainly that the nano-antibacterial particles 21 are in contact with and destroy the cell membrane 31 of the bacteria 3 in the air, so that the tissue fluid of the bacteria 3 flows out, and the protein coagulates to make the bacteria 3 inactive. Eventually, the bacteria 3 are killed due to the hindered DNA synthesis and loss of the ability to divide and reproduce. An antibacterial effect is definitely achieved.

However, whether nano-titanium dioxide or nano-zinc oxide is used as the antibacterial nano-particles 21, or nano-silver is used as the antibacterial nano-particles 21, most of the antibacterial nano-particles 21 are dispersed deeply inside the antibacterial coating layer 20 and only a few of the antibacterial nano-particles 21 are exposed from the surface of the coating layer 20, since the antibacterial nano-particles 21 are added to the antibacterial coating layer 20 by doping and stirring before the coating step. As a result, the most nano-antibacterial particles 21 located deeply inside the antibacterial coating layer 20 cannot exert a bactericidal effect, causing a waste. There are only a few antibacterial nano-particles 21 exposed from the surface of the coating layer 20, making the antibacterial effect of the conventional antibacterial coating layer 20 limited.

Therefore, there is a need for an antibacterial coating layer that can overcome the above problems.

### SUMMARY

An object of the present disclosure is to provide an antibacterial coating layer, in which all of the antibacterial nano-particles are located near a surface of a coating.

To achieve the above objective, the present disclosure provides an antibacterial coating layer including: a coating; and a plurality of antibacterial nano-particles, all located near a surface of the coating material.

The present disclosure further provides a coating method for an antibacterial coating layer including the following steps of: applying a coating onto a substrate; when the coating material is in a semi-dried state, spraying a nano-antibacterial solution containing a plurality of antibacterial nano-particles on the coating material; and forming an antibacterial coating layer when the coating material and the antibacterial nano-particles are in a completely dried stage, wherein the antibacterial nano-particles are all located near the surface of the coating material.

According to the antibacterial coating layer of the present disclosure, no antibacterial nano-particles are dispersed deeply inside the coating material, so no waste is caused, and thus the cost is reduced. All the antibacterial nano-particles are located near the surface of the coating material, for example, the antibacterial nano-particles can be exposed from the surface of the coating material, so that the antibacterial effect of the antibacterial coating layer is not limited, and the best antibacterial effect can be achieved.

### BRIEF DESCRIPTION OF THE DRAWINGS

FIG. 1 is a schematic cross-sectional view of a conventional antibacterial coating layer.

FIG. 2 is a flow chart of a coating method according to an embodiment of the present disclosure.

FIG. 3 is a schematic cross-sectional view of a coating method according to an embodiment of the present disclosure, showing that a coating is coated on a substrate.

FIG. 4 is a schematic cross-sectional view of a coating method according to an embodiment of the present disclosure, showing a plurality of antibacterial nano-particles are sprayed on a coating.

FIG. 5 is a schematic cross-sectional view of an antibacterial coating layer according to an embodiment of the present disclosure.

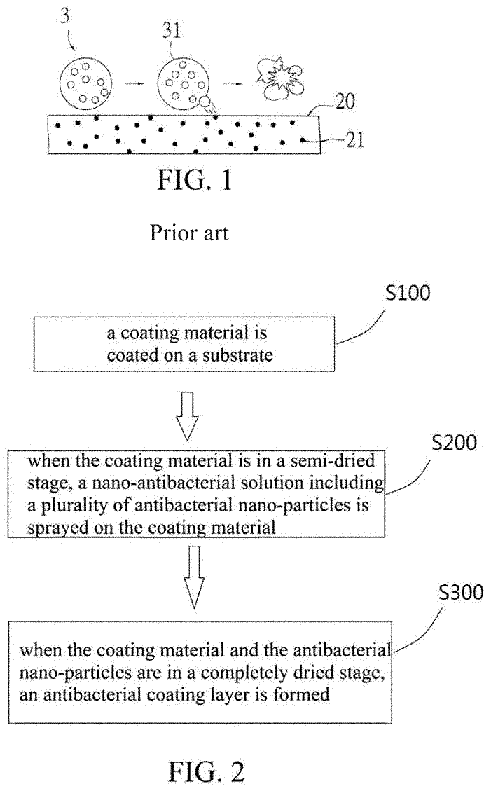

### DETAILED DESCRIPTION

To make the foregoing objects, features, and characteristics of the present disclosure more comprehensible, related embodiments of the present disclosure are described in detail below with reference to the drawings.

FIG. 2 is a flow chart of a coating method according to an embodiment of the present disclosure. The coating method includes the following steps.

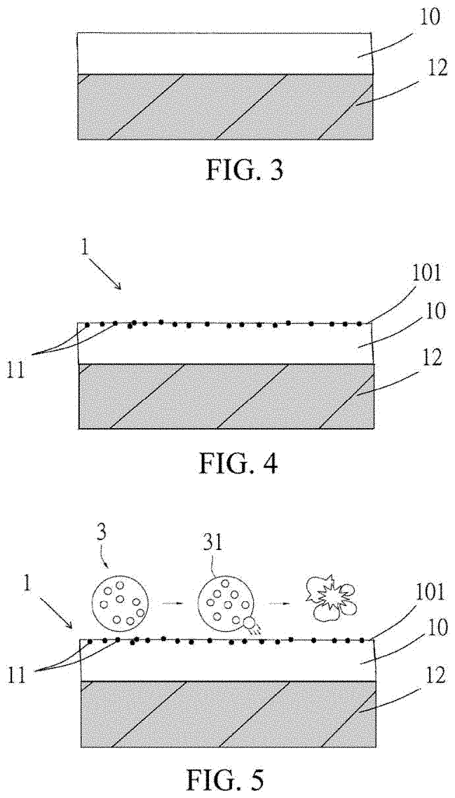

Referring to FIG. 3, in Step S100, a coating material 10 is coated on a substrate 12. The coating material 10 can be an aqueous coating material (it is defined as an aqueous coating material as long as the coating material can be diluted with water). For example, the composition of the aqueous coating material includes 50 KG of a first aqueous resin (such as acrylic resin), 50 KG of a second aqueous resin (such as polyurethane dispersion resin), 0.4 KG of a first defoamer (such as polyether-siloxane copolymer emulsion), 2 KG of an adhesive, 4 KG of a matting agent, 1.2 KG of a second defoamer (such as xylene-polysiloxane emulsion), 4 KG of a reverse osmosis (RO) water, 0.5 KG of a pinhole removal aid, and 11 KG of a black color paste. The coating process is at least one of bar coating process, slide coating process, curtain coating process, and spray coating process, and the substrate 12 can be an organic substrate (such as wood or plastic) or an inorganic material (such as metal or glass).

Referring to FIG. 4, in Step S200, when the coating material 10 is in a semi-dried stage, i.e., a nearly but not fully dried stage (for example, the coating material 10 is in a semi-soft and semi-hard state, not yet fully hardened, or is gelatinous), a nano-antibacterial solution including a plurality of antibacterial nano-particles 11 is sprayed on the coating material 10. The nano-antibacterial solution is suitable for being sprayed on a colored or transparent coating material. If the nano-antibacterial solution is dilutable with water, it can be defined as an aqueous nano-antibacterial solution. For example, the antibacterial nano-particles 11 may be nano-silver with a content of 0.05 to 2%, with the balance being water as a solvent. The nano-silver content is preferably 0.05 to 1%. The nano-antibacterial solution may also be incorporated with an organic solvent. The particle size of these antibacterial nano-particles 11 is less than 10 nanometers, and preferably between about 3 and 5 nanometers. As for the density of the antibacterial nano-particles 11 located near the surface 101 of the coating material 10, a 10,000 to 12000 ppm of nano-antibacterial solution containing antibacterial nano-particles 11 is used, and then 8 to 20 grams of the nano-antibacterial solution is sprayed on one square meter of the coating material 10, to allow the antibacterial coating layer have a better antibacterial effect.

Referring to FIG. 4 again, in Step S300, when the coating material 10 and the antibacterial nano-particles 11 are in a completely dried stage (for example, the coating material 10 is in fully hardened state), an antibacterial coating layer 1 is formed. The antibacterial nano-particles 11 are all located near the surface 101 of the coating material 10. For example, the antibacterial nano-particles 11 can be exposed from the surface 101 of the coating material 10. For example, the completely dried stage (for example, drying by natural drying or forced drying) has a completion time, to allow the coating material 10 to reach a completely dried state, and the moisture in the nano antibacterial solution to evaporate. The semi-dried state continues for a predetermined time (for example, the predetermined time may be between 1 to 60 minutes, preferably between 1 to 30 minutes, and most preferably between 1 to 10 minutes). The predetermined time of the semi-dried state is shorter than the completion time of the complete dried stage, so that the coating material 10 is allowed to reach a semi-dried state. In this embodiment, the antibacterial nano-particles 11 are nano metal (for example, nano-silver). In another embodiment, the antibacterial nano-particles 11 may also be nano metal oxides (such as nano-titania or nano-zinc oxide). When the coating material 10 is in the semi-dried state, the antibacterial nano-particles 11 are sprayed on the coating material 10. Since the coating material 10 is controlled to be in the semi-dried state, the antibacterial nano-particles 11 will not sink deeply into the coating material 10. At this time, the coating material 10 is sufficiently viscous to adhere the antibacterial nano-particles 11 without having to provide an additional adhesive material. When the coating material 10 is in the completely dried stage, the moisture in the nano antibacterial solution is evaporated. At this time, the antibacterial nano-particles 11 will be embedded, inserted, or stuck to the surface 101 of the coating material 10. There is sufficient adhesion force between the coating material 10 and the antibacterial nano-particles 11, to immobilize the antibacterial nano-particles 11 near the surface 101 of the coating material 10. After being completely dried, the antibacterial nano-particles 11 and the coating material 10 have a scratch resistance of more than 200 cycles and an adhesion of 5 b therebetween, as shown by a scratch resistance test by steel wool #0000 at 500 g. Furthermore, after the coating material 10 and the antibacterial nano-particles 11 are completely dried, an antibacterial coating layer 1 having high gloss and good antibacterial effect can be obtained.

Referring to FIG. 5, the nano-antibacterial particles 11 of the present disclosure are in contact with and destroy the cell membrane 31 of the bacteria 3 in the air, so that the tissue fluid of the bacteria 3 flows out, and the protein coagulates to make the bacteria 3 inactive. Eventually, the bacteria 3 are killed due to the hindered DNA synthesis and loss of the ability to divide and reproduce. An antibacterial effect is definitely achieved. Furthermore, if the antibacterial nano-particles in the nano-antibacterial solution of the present disclosure have an antiviral effect, the antibacterial nano-particles after drying also have an antiviral effect.

According to the antibacterial coating layer of the present disclosure, no antibacterial nano-particles are dispersed deeply inside the coating material, so no waste is caused, and thus the cost is reduced. All the antibacterial nano-particles are located near the surface of the coating material, for example, the antibacterial nano-particles can be exposed from the surface of the coating material, so that the antibacterial effect of the antibacterial coating layer is not limited, and the best antibacterial effect can be achieved.

In summary, the present disclosure has been described with reference to preferred embodiments or examples of the present disclosure, which however are not intended to limit the scope of the present disclosure. Equal changes and modifications made according to, or without departing from the scope of the present disclosure are covered in the scope of claims of the present disclosure.

What is claimed is:

1. An antibacterial coating layer, comprising:
a coating; and
a plurality of antibacterial nano-particles, all located near a surface of the coating material.

2. The antibacterial coating layer according to claim 1, wherein the antibacterial nano-particles are embedded, inserted, or stuck to the surface of the coating material, and there is an adhesion force between the coating material and the antibacterial nano-particles, to immobilize the antibacterial nano-particles near the surface of the coating material.

3. The antibacterial coating layer according to claim 2, wherein after being completely dried, the antibacterial nano-particles and the coating have a scratch resistance of more than 200 cycles and an adhesion of 5 b therebetween, as shown by a scratch resistance test by steel wool #0000 at 500 g.

4. The antibacterial coating layer according to claim 1, wherein the antibacterial nano-particles are a nano metal, or a nano metal oxide.

5. The antibacterial coating layer according to claim 4, wherein the nano metal is nano-silver, and the nano metal oxide is nano-titania or nano-zinc oxide.

6. The antibacterial coating layer according to claim 1, further comprising a substrate, wherein the coating material is provided on the substrate, and the substrate is an organic substrate or an inorganic substrate.

7. The antibacterial coating layer according to claim 1, wherein the particle size of these antibacterial nano-particles is less than 10 nanometers.

8. The antibacterial coating layer according to claim 7, wherein the particle size of these antibacterial nano-particles is between about 3 and 5 nanometers.

9. The antibacterial coating layer according to claim 1, wherein as for the density of the antibacterial nano-particles located near the surface of the coating material, a 10,000 to 12000 ppm of nano-antibacterial solution containing antibacterial nano-particles is used, and then 8 to 20 grams of the nano-antibacterial solution is sprayed on one square meter of the coating material.

10. A coating method for an antibacterial coating layer, comprising the following steps of:
applying a coating onto a substrate;
when the coating material is in a semi-dried state, spraying a nano-antibacterial solution containing a plurality of antibacterial nano-particles on the coating material; and
forming an antibacterial coating layer when the coating material and the antibacterial nano-particles are in a completely dried stage, wherein the antibacterial nano-particles are all located near the surface of the coating material.

11. The coating method for an antibacterial coating layer according to claim 10, wherein the completely dried stage has a completion time, to allow the coating material to reach the completely dried state; and the semi-dried state continues for a predetermined time, wherein the predetermined time of the semi-dried state is shorter than the completion time of the completely dried stage, so that the coating material is allowed to reach the semi-dried state.

12. The coating method for an antibacterial coating layer according to claim 11, wherein the predetermined time of the semi-dried state is from 1 to 60 minutes.

13. The coating method for an antibacterial coating layer according to claim 12, wherein between the predetermined time of the semi-dried state is 1 to 30 minutes.

14. The coating method for an antibacterial coating layer according to claim 13, wherein between the predetermined time of the semi-dried state is 1 to 10 minutes.

15. The coating method for an antibacterial coating layer according to claim 10, wherein the antibacterial nano-particles are embedded, inserted, or stuck to the surface of the coating material, and there is an adhesion force between the coating material and the antibacterial nano-particles, to immobilize the antibacterial nano-particles near the surface of the coating material.

16. The coating method for an antibacterial coating layer according to claim 15, wherein after being completely dried, the antibacterial nano-particles and the coating have a scratch resistance of more than 200 cycles and an adhesion of 5 b therebetween, as shown by a scratch resistance test by steel wool #0000 at 500 g.

17. The coating method for an antibacterial coating layer according to claim 10, wherein the antibacterial nano-particles are a nano metal, or a nano metal oxide.

18. The coating method for an antibacterial coating layer according to claim 17, wherein the nano metal is nano-silver, and the nano metal oxide is nano-titania or nano-zinc oxide.

19. The coating method for an antibacterial coating layer according to claim 10, wherein the particle size of these antibacterial nano-particles is between about 3 and 5 nanometers.

20. The coating method for an antibacterial coating layer according to claim 10, wherein as for the density of the antibacterial nano-particles located near the surface of the coating material, a 10,000 to 12000 ppm of nano-antibacterial solution containing antibacterial nano-particles is used, and then 8 to 20 grams of the nano-antibacterial solution is sprayed on one square meter of the coating material.
